(19) United States
(12) Patent Application Publication
(10) Pub. No.: US 2026/0257378 A1
(43) Pub. Date: Sep. 3, 2026

(54) Vacuum Applicator for Thermal Pads

(71) Applicant: Mellanox Technologies, Ltd., Yokneam (IL)

(72) Inventors: Stanislav Bogomolnyi, Nesher (IL); Alex Weiss, Tirat Carmel (IL); Avi Levi, Adi (IL); Eran Zehavi, Nahariya (IL)

(21) Appl. No.: 19/257,576

(22) Filed: Jul. 2, 2025

Related U.S. Application Data
(60) Provisional application No. 63/765,642, filed on Mar. 2, 2025.

(51) Int. Cl. B25J 15/06

(52) U.S. Cl. CPC B25J 15/0616

(57) ABSTRACT

The disclosure describes an applicator having a housing to engage a thermal pad, the applicator housing including one or more suction ports coupled to a vacuum generator to generate a suction hold on the pad in response to the suction generated by the vacuum generator. The disclosure also describes a method for affixing a thermal pad to a target surface within a tester. The method includes engaging a first side of the pad to a side of an applicator housing of an applicator, the side of the applicator housing including one or more suction ports, and applying a vacuum to the one or more suction ports so as to generate a suction hold on the first side of the pad. The method also includes affixing the applicator to a target surface so as to engage a second side of the pad, thereby securing the pad to the target surface.

### CROSS-REFERENCE TO RELATED APPLICATIONS

This application claims the benefit of U.S. Provisional Patent Application 63/765,642, filed Mar. 2, 2025, which is incorporated herein by reference.

### TECHNICAL FIELD

The present disclosure relates generally to component testing, and particularly to installing thermal pads to a testing apparatus for optical transceivers.

### BACKGROUND

Optical transceivers are high-speed, high-density electronic modules that generate significant heat during operation, especially as data rates and power densities increase in modern data centers and telecom racks. Thermal pads are essential because they serve as thermal interface materials (TIMs), providing a low-resistance path for heat to move from the heat-generating components inside the transceiver (such as lasers, drivers, and DSPs) to external heat sinks.

The physical connection between the transceiver module and its heatsink is rarely perfectly flat, as there are typically microscopic air gaps and surface irregularities. Air is a poor conductor of heat, so these gaps can significantly impede thermal transfer. Thermal pads are soft, conformable materials that fill these gaps, ensuring a much larger contact area and enabling efficient heat flow away from the sensitive electronics.

Without proper thermal management, including the use of thermal pads, hot spots can develop inside the transceiver. This can lead to reduced performance, thermal throttling, or even permanent damage to the module. By improving heat transfer, thermal pads help maintain optimal operating temperatures, thereby enhancing the reliability and lifespan of the optical transceivers, which is especially critical in densely packed racks where airflow may be limited and ambient temperatures can be higher.

The description above is presented as a general overview of related art in this field and should not be construed as an admission that any of the information it contains constitutes prior art against the present patent application.

### GENERAL DESCRIPTION

There is provided, in accordance with an embodiment of the present invention, an apparatus including an applicator having an applicator housing to engage a thermal pad, the applicator housing including one or more suction ports coupled to a vacuum generator to generate a suction hold on the thermal pad in response to the suction generated by the vacuum generator.

In one embodiment, the vacuum generator operates using 6 bar compressed air.

In another embodiment, the vacuum generator includes a Venturi vacuum generator.

In an additional embodiment, the applicator housing is to engage the thermal pad by engaging a non-adhesive side of the thermal pad, and wherein the suction hold on the non-adhesive side of the thermal pad affixes a second, adhesive side of the thermal pad to a target surface in a tester.

In a first tester embodiment, the tester includes a receptacle to receive a transceiver module, and wherein the applicator housing has an external form factor shaped to fit into the receptacle.

In a second tester embodiment, the external form factor includes a network transceiver form factor.

In a third tester embodiment, the network transceiver form factor includes a Small Form-factor Pluggable (SFP) form factor.

In a fourth tester embodiment, the receptacle aligns the thermal pad with the target surface upon receiving the applicator.

In a fifth tester embodiment, the tester includes a heat sink, and wherein the target surface is coupled to the heat sink.

In a further embodiment, the applicator housing includes a recessed cutout formed in a side of the applicator housing to encompass the non-adhesive side of the thermal pad, wherein the recessed cutout includes the one or more suction ports, an internal channel disposed within the applicator housing, and a suction inlet to connect to the vacuum generator for introducing the suction to the internal channel, wherein the internal channel leads from the suction inlet to the one or more suction ports in the recessed cutout, so that the one or more suction ports generate the suction hold on the non-adhesive side of the thermal pad in response to introducing the suction to the suction inlet.

In a supplemental embodiment, the applicator housing is to affix the second adhesive side of the thermal pad to the target surface in response to repositioning the target surface so as to engage the adhesive side of the thermal pad.

In one embodiment, the thermal pad includes a first thermal pad, wherein the recessed cutout includes a first recessed cutout, and wherein the target surface includes a first target surface, and further including a second recessed cutout formed in a second side of the applicator housing to encompass a non-adhesive side of a second thermal pad also having a second, adhesive side.

In another embodiment, the applicator housing is to affix the adhesive side of the second thermal pad to a second target surface.

In an additional embodiment, the applicator housing is to affix the second adhesive side of the second thermal pad to the target surface in response to repositioning the second target surface so as to engage the adhesive side of the second thermal pad.

In a further embodiment, the second side of the applicator housing is opposite the first side of the applicator housing.

There is provided, in accordance with an embodiment of the present invention, a method for affixing a thermal pad to a target surface within a tester, including engaging a first side of the thermal pad to a side of an applicator housing of an applicator, the side of the applicator housing including one or more suction ports, applying a vacuum to the one or more suction ports so as to generate a suction hold on the first side of the thermal pad, and affixing the applicator to a target surface so as to engage a second side of the thermal pad, thereby securing the thermal pad to the target surface.

In one embodiment, engaging the first side of the thermal pad to the side of an applicator housing includes the applicator housing engaging a non-adhesive side of the thermal pad.

In another embodiment, engaging the non-adhesive side of the thermal pad includes engaging, by a recessed cutout formed in a side of the applicator housing to encompass the thermal pad, the non-adhesive side of the thermal pad, wherein the recessed cutout includes the one or more suction ports;

In an additional embodiment, affixing the second adhesive side of the thermal pad to the target surface includes repositioning the applicator housing including the target surface so as to engage the adhesive side of the thermal pad.

In a further embodiment, the thermal pad includes a first thermal pad, wherein the recessed cutout includes a first recessed cutout, and wherein the target surface includes a first target surface, and further including engaging, by a second recessed cutout formed in a second side of the applicator housing to encompass a second thermal pad, a non-adhesive side of a second thermal pad also having a second, adhesive side.

In a supplemental embodiment, the method further includes affixing the adhesive side of the second thermal pad to a second target surface in response to repositioning the applicator housing including the second target surface.

### BRIEF DESCRIPTION OF THE DRAWINGS

The disclosure is herein described, by way of example only, with reference to the accompanying drawings, wherein:

FIG. 1 is a schematic pictorial illustration showing an example of a testing facility comprising an optical transceiver tester and an applicator coupled to a vacuum generator, in accordance with an embodiment of the present disclosure;

FIG. 2 is a schematic pictorial illustration showing the bottom side of the applicator, in accordance with an embodiment of the present disclosure;

FIG. 3 is a schematic pictorial illustration showing a cutaway view of the applicator, in accordance with an embodiment of the present disclosure;

FIG. 4 is a schematic pictorial illustration showing the top side of the applicator, in accordance with an embodiment of the present disclosure;

FIG. 5 is a flow diagram that schematically illustrates a method for installing, using the applicator, thermal pads into the optical transceiver tester, in accordance with an embodiment of the present disclosure.

FIG. 6 is a schematic pictorial illustration showing an operator affixing the bottom thermal pad to the bottom side of the applicator, in accordance with an embodiment of the present disclosure;

FIG. 7 is a schematic pictorial illustration showing the operator affixing the top thermal pad to the top side of the applicator, in accordance with an embodiment of the present disclosure;

FIG. 8 is a schematic pictorial illustration showing details of the optical transceiver tester, in accordance with an embodiment of the present disclosure;

FIG. 9 is a schematic pictorial illustration showing the operator inserting the applicator into a receptacle of the optical transceiver tester while the pedestals are separated, in accordance with an embodiment of the present disclosure;

FIG. 10 is a schematic pictorial illustration showing the applicator inserted into the receptacle, in accordance with an embodiment of the present disclosure;

FIG. 11 is a schematic pictorial illustration showing the pedestals pressing against the applicator so as to affix the thermal pads on top and bottom target surfaces in the optical transceiver tester, in accordance with an embodiment of the present disclosure;

FIG. 12 is a schematic pictorial illustration showing the operator removing the applicator from the receptacle while the pedestals are separated, in accordance with an embodiment of the present disclosure;

FIG. 13 is a schematic pictorial illustration showing the optical transceiver tester subsequent to the operator removing the applicator from the receptacle, in accordance with an embodiment of the present disclosure;

FIG. 14 is a schematic pictorial illustration showing the top thermal pad affixed to the top target surface, in accordance with an embodiment of the present disclosure;

FIG. 15 is a schematic pictorial illustration showing the bottom thermal pad affixed to the bottom target surface, in accordance with an embodiment of the present disclosure;

FIG. 16A is a block diagram of a network architecture, and FIG. 16B is an illustration of a datacenter implementing the architecture, in accordance with an embodiment of the present disclosure;

FIGS. 17A and 17B are illustrations showing a top view and a perspective view, respectively, of an optical transceiver module operatively coupled to a network adapter, in accordance with an embodiment of the disclosure;

FIG. 18 depicts exemplary scenarios for use of an optical transceiver, in accordance with some embodiments of the present disclosure;

FIG. 19 is a block diagram that schematically illustrates an example of a network device, in accordance with an embodiment of the present disclosure;

FIG. 20 illustrates an example of a computing environment, in accordance with at least one embodiment of the present disclosure; and

FIG. 21 illustrates an example network configuration of components that can be used to provide, generate, modify, encode, process, fuse, and/or transmit generated image data, calculated measurements, or other such content, in accordance with an embodiment of the present disclosure.

### DETAILED DESCRIPTION OF EMBODIMENTS

Optical transceivers are tested during manufacturing to ensure they meet performance, reliability, and industry standards before being deployed in networks. These components play a crucial role in data transmission, and any defects or inefficiencies can lead to signal degradation, increased latency, or complete communication failure. Testing verifies factors such as optical power output, wavelength accuracy, signal integrity, and interoperability with different systems, helping manufacturers identify and eliminate defects early.

Optical transceiver testers (also referred to herein simply as testers, testing stations or “jigs”) typically use thermal pads to maintain stable operating temperatures during testing on the production line, ensuring accurate performance assessments and preventing overheating that could skew results. These pads help dissipate heat generated by the transceiver under load, improving thermal conductivity between the device and cooling surfaces and alignment. It helps to mitigate issues caused by misalignment of metal parts, which can lead to poor thermal conductivity. By effectively managing temperature fluctuations, thermal pads allow testers to simulate real-world conditions, verifying the transceiver's reliability and efficiency in various environments.

During manufacturing, optical transceivers are typically tested in a jig equipped with thermal pads that press against the transceiver when the jig is closed. However, repeated use of the jig can cause thermal pads to degrade due to factors such as material fatigue, mechanical compression and wear. Thermal pads in testers typically need to be frequently replaced because they degrade over time due to constant exposure to heat cycles, pressure, and environmental factors. As thermal conductivity diminishes, the pads become less effective at regulating temperature, potentially leading to inaccurate test readings and inefficient heat dissipation. Regular replacement ensures consistent thermal performance, maintaining testing accuracy and preventing damage to transceivers or the testing equipment itself.

However, the thermal pads are not easily accessible and replacing thermal pads in an optical transceiver tester requires disassembling the jig's upper part and removing the board which is typically a time-consuming process and require a mechanical recalibration because it requires precise disassembly and reassembly of delicate components to ensure proper thermal conductivity. The pads must be carefully removed without damaging the underlying surfaces, and any residual material has to be thoroughly cleaned to prevent heat dissipation issues. Aligning and installing new thermal pads demands accuracy, as even minor misalignment can lead to performance degradation.

Embodiments of the present disclosure include an applicator configured to install thermal pads in an optical transceiver tester without disassembling the jig's upper part and removing the board and without requiring any mechanical recalibration greatly reducing maintenance time. As described hereinbelow, the applicator has an applicator housing configured to engage a thermal pad, and the applicator housing comprises a set of one or more suction ports coupled to a vacuum generator configured to generate a suction hold on the thermal pad in response to the suction generated by the vacuum generator. This configuration enables thermal pad replacement faster and more accurately.

When inserting the applicator into a receptacle the applicator housing has a top side oriented away from a gravitational force and a bottom side opposite the top side and oriented toward the gravitational force. In embodiments described hereinbelow, the bottom side comprises the set of suction ports that deliver the suction hold so as to hold the thermal pad in place when the bottom side is oriented toward the gravitational force. In these embodiments, an additional thermal pad is placed on the top side of the applicator housing, and is kept in place by the gravitational force when inserting the applicator into the receptacle.

As described hereinbelow, each thermal pad comprises adhesive side, and a non-adhesive side that rests on the applicator housing. In some embodiments, the external form factor of the applicator housing matches the form factor of the transceiver (e.g. OSFP module) allowing insertion into the jig. The external form factor of the applicator housing may comprise a Small Form-factor Pluggable (SFP) form factor. This enables the applicator to be inserted into the tester's receptacle (i.e., without any modification to the tester) so as to affix the adhesive sides of the thermal pads to respective target surfaces in the tester.

### SYSTEM DESCRIPTION

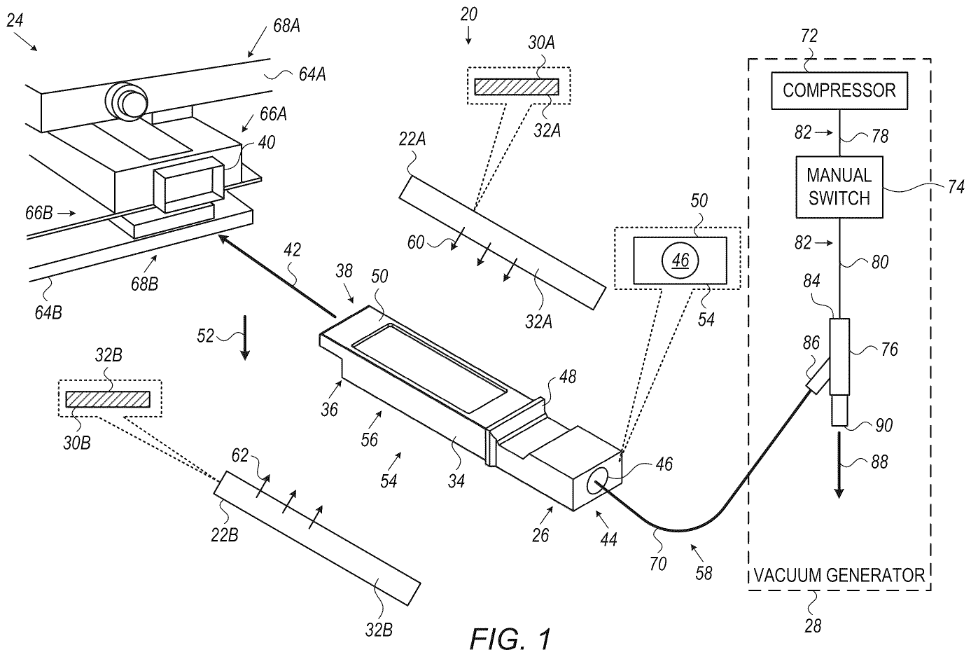

FIG. 1 is a schematic pictorial illustration of an optical transceiver testing system 20 comprising an applicator 26 configured to install thermal pads 22 into an optical transceiver tester 24 (also referred to herein simply as tester 24) that is used to test optical transceivers (not shown), in accordance with an embodiment of the present disclosure. In the configuration shown in FIG. 1, system 20 comprises tester 24, applicator 26, and a vacuum generator 28.

In some embodiments, each thermal pad 22 comprises an adhesive side 30 and a non-adhesive side 32. In embodiments herein thermal pads 22, adhesive sides 30 and non-adhesive sides 32 can be differentiated by appending a letter to the identifying numeral, so that the thermal pads comprise top thermal pad 22A and bottom thermal pad 22B, wherein top thermal pad 22A comprises top adhesive side 30A and top non-adhesive side 32A opposite side 30A, and wherein bottom thermal pad 22B comprises bottom adhesive side 30B and bottom non-adhesive side 32B opposite side 30B.

Applicator 26 comprises an applicator housing 34 configured to engage thermal pads 22, wherein the applicator housing may have an external form factor 36 matching a network transceiver form-factor. In some embodiments, the network transceiver form-factor may comprise an active copper transceiver form-factor, a co-packaged optics (CPO) transceiver form-factor, or a Small Form-factor Pluggable (SFP) form factor. Examples of SFP form factors include, but are not limited to, OCTAL Small Form-factor Pluggable (OSFP), Small Form-Factor Pluggable Double Density (SFP-DD), Quad Small Form-factor Pluggable (QSFP) and Quad Small Form Factor Pluggable Double Density (QSFP-DD).

Applicator housing 34 may comprise a first end 38 configured to be inserted into a receptacle 40 of tester 24 (as indicated by an arrow 42), and a second end 44 opposite the first end and comprising a suction inlet 46. In some embodiments, applicator housing 34 comprises a stopper 48 that protrudes from the applicator housing so as to limit the insertion of the applicator housing into receptacle 40.

In embodiments herein, receptacle 40 is configured to receive an optical transceiver module having an SFP form factor. Therefore, since external form factor 36 of applicator housing 34 matches an SFP form factor, the applicator housing is configured to fit into receptacle 40.

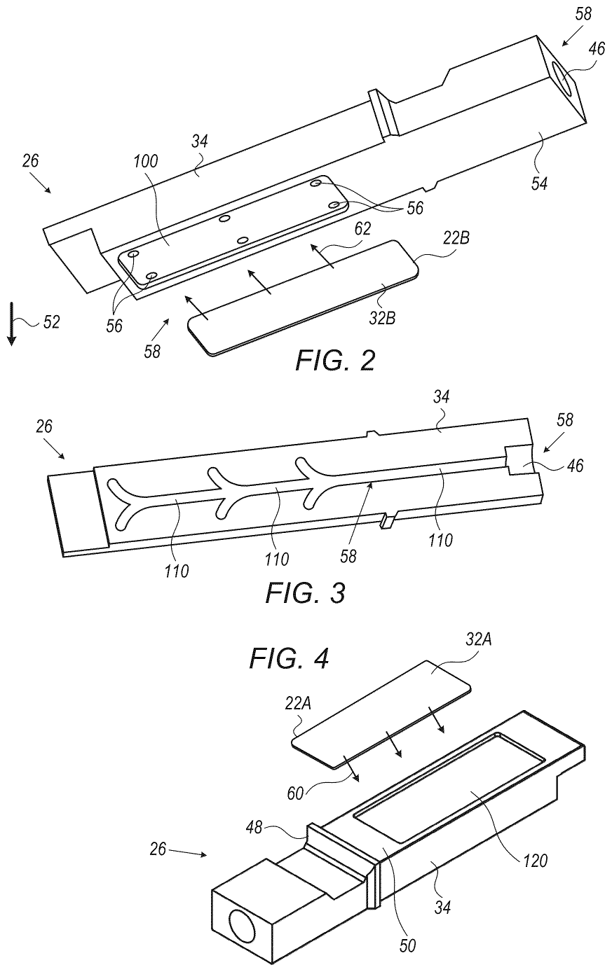

When inserting applicator housing 34 into receptacle 40, the applicator housing has a top side 50 oriented away from a gravitational force 52, and a bottom side 54 oriented toward the gravitational force. In embodiments described herein, the bottom side applicator housing 34 comprises one or more suction ports 56 coupled to vacuum generator 28 and is configured to generate a suction hold on thermal pad 22B in response to suction 58 generated by the vacuum generator. As described hereinbelow, suction inlet 46 receives and conveys suction 58 to suction ports 56. Details of suction ports 56 are described in the description referencing FIG. 2 hereinbelow.

In embodiments described herein, upon engaging non-adhesive side 30A of thermal pad 22A to top side 50 (as indicated by arrows 60), thermal pad 22A remains affixed to the top side of applicator housing 34 due to a gravitational force 52. However, upon engaging non-adhesive side 30B of thermal pad 22B to bottom side 54 (as indicated by arrows 62), thermal pad 22B remains affixed to the bottom side of applicator housing 34 due to suction 58 delivered to suction ports 56 (i.e., since adhesive side 30B of thermal pad 22B is oriented toward gravitational force 52, suction 58 keeps thermal pad 22B affixed to bottom side 54 of applicator housing 34).

In addition to receptacle 40, tester 24 (i.e., a “jig”) may comprises pedestals 64 comprising respective target surfaces 66 that are coupled to respective heat sinks 68. In embodiments herein, applicator housing 34 is configured to engage thermal pads 22 by engaging non-adhesive sides 32 of the thermal pads, and the suction hold (i.e., generated by suction 58) on the non-adhesive side of the bottom thermal pad used is used when affixing adhesive sides 30 of the thermal pads to target surfaces 66.

In some embodiments, pedestals 64, target surfaces 66 and heat sinks 68 can be differentiated by appending a letter to the identifying numeral, so that the pedestals comprise top pedestal 64A and bottom pedestal 64B, the target surfaces comprise top target surface 66A and bottom target surface 66B, and the heat sinks comprise top heat sink 68A and bottom heat sink 68B. In the configuration shown in FIG. 1, top pedestal 64A comprises top target surface 66A that is coupled to top heat sink 68A, and bottom pedestal 64B comprises bottom target surface 66B that is coupled to bottom heat sink 68B.

In embodiments described herein, vacuum generator 28 delivers suction 58 to suction inlet 46 via a suction line 70. In the configuration shown in FIG. 1, vacuum generator 28 comprises a compressor 72, a manual switch 74, a Vacuum Venturi 76 a first air conduit 78 coupling the compressor to the manual switch, and a second air conduit 80 coupling the manual switch to the Venturi vacuum generator. In some embodiments, compressor 72 operates using (i.e., generates) 6 bar compressed air 82. This configuration eliminates the need for additional equipment, has no moving parts and has a single component.

To generate suction 58, in response to an operator (not shown in FIG. 1) engaging manual switch 74, compressor 72 delivers compressed air 82 to Vacuum Venturi 76 via air conduits 78 and 80. In response to receiving compressed air 82 via a compressed air inlet 84, Vacuum Venturi 76 generates and delivers suction 58 to suction line 70 via a vacuum port 86, and generates and expels an exhaust 88 (i.e. air exhaust) via an exhaust port 90.

In some embodiments, manual switch 74 is configured to cycle between an on position (which allows delivery of compressed air 82 to second air conduit 80) and an off position (which inhibits delivery of the compressed air to the second air conduit 80). In the configuration shown in FIG. 1, vacuum generator 28 initiates delivery of suction 58 to suction ports 56 in response cycling manual switch 74 to the on position, and the vacuum generator terminates delivery of the suction to the suction ports) in response cycling the manual switch 74 to the off position.

FIG. 2 is a schematic pictorial illustration showing details of bottom side 54 of applicator housing 34, and FIG. 3 is a schematic pictorial illustration showing a cutaway view of the applicator in accordance with embodiments of the present disclosure.

As shown in FIGS. 2 and 3, applicator housing 34 comprises a bottom recessed cutout 100 formed in bottom side 54, and the bottom recessed cutout is configured to encompass non-adhesive side 32B of thermal pad 22B. Bottom recessed cutout 100 comprises one or more suction ports 56 that are coupled to suction inlet 46 via an internal channel 110 disposed within applicator housing 34.

In the configuration shown in FIGS. 1-3, Vacuum Venturi 76 generates suction 58 and delivers the suction to suction inlet 46 via suction line 70. In this configuration, suction inlet 46 connects to vacuum generator 28 so as to introduce suction 58 to internal channel 110, and internal channel 110 leads from suction inlet 46 to suction ports 56 in a bottom recessed cutout 100. This configuration enables suction ports 56 to generate a suction hold on non-adhesive side 32B of thermal pad 22B in response to introducing suction 58 to suction inlet 46.

FIG. 4 is a schematic pictorial illustration showing top side 50 of applicator housing 34, in accordance with an embodiment of the present disclosure. In the configuration shown in FIG. 4, applicator 26 comprises a top recessed cutout 120 formed in top side 50 side of applicator housing 34, and the top recessed cutout is configured encompass non-adhesive side 32A of thermal pad 22A (which also has adhesive side 30A).

### THERMAL PAD INSTALLATION

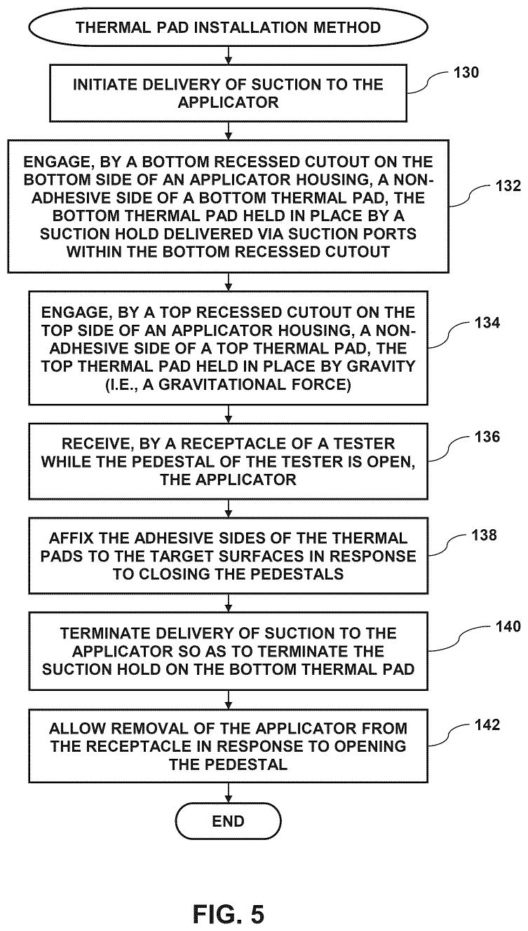

FIG. 5 is a flow diagram that schematically illustrates a method for using applicator 26 to install thermal pads 22 in optical transceiver tester 24, in accordance with an embodiment of the present disclosure.

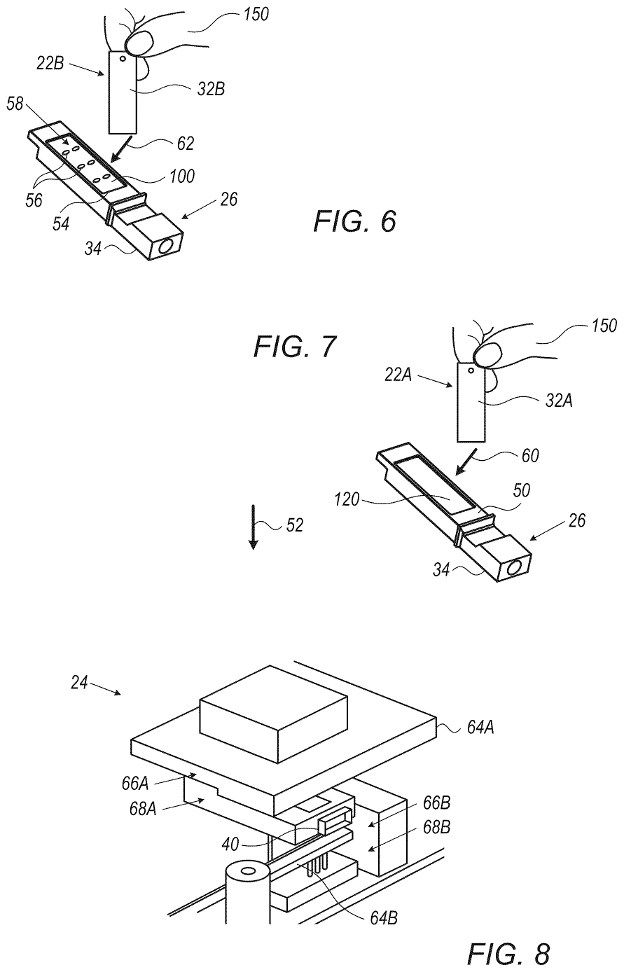

In step 130, in response to an operator (i.e., an individual as described in the description referencing FIG. 6 hereinbelow) turning on compressor 72 and cycling manual switch 74 to the on position, vacuum generator 28 initiates delivery of suction 58 to applicator 26.

In step 132, bottom recessed cutout 100 engages (i.e., is\grave{ } secured to to) non-adhesive side 32B of thermal pad 22B, so as to couple the non-adhesive side of the bottom thermal pad to the bottom recessed cutout.

FIG. 6 is a schematic pictorial illustration showing operator 150 securing non-adhesive side 32B of thermal pad 22B to bottom recessed cutout 100 of applicator housing 34, in accordance with an embodiment of the present disclosure. As described supra, suction 58 from suction ports 56 generates a suction hold on non-adhesive side 32B of thermal pad 22B that keeps the non-adhesive side of the bottom thermal pad 22B affixed to bottom recessed cutout 120. The suction hold enables non-adhesive side 32B of thermal pad 22B to remain secured to bottom recessed cutout 100 even when applicator housing 34 is positioned (i.e., rotated) so that bottom side 54 of the applicator housing is oriented toward gravitational force 52.

In step 134, top recessed cutout 120 engages non-adhesive side 32A of thermal pad 22A, so as to couple the non-adhesive side of the top thermal pad to the top recessed cutout.

FIG. 7 is a schematic pictorial illustration showing operator 150 securing non-adhesive side 32A of thermal pad 22A to top recessed cutout 120 of applicator housing 34, in accordance with an embodiment of the present disclosure. As described supra, gravitational force 52 affixes non-adhesive side 32A of thermal pad 22A to top recessed cutout 120.

In step 136, in response to operator 150 inserting applicator housing 34 into receptacle 40, the receptacle receives applicator 26.

FIG. 8 is a schematic pictorial illustration showing a configuration of optical transceiver tester 24 prior to inserting applicator 26, in accordance with an embodiment of the present disclosure. In FIG. 8, pedestals 64 are positioned away from each other (i.e., the pedestals are “open”), so as to allow insertion of applicator housing 34 into receptacle 40.

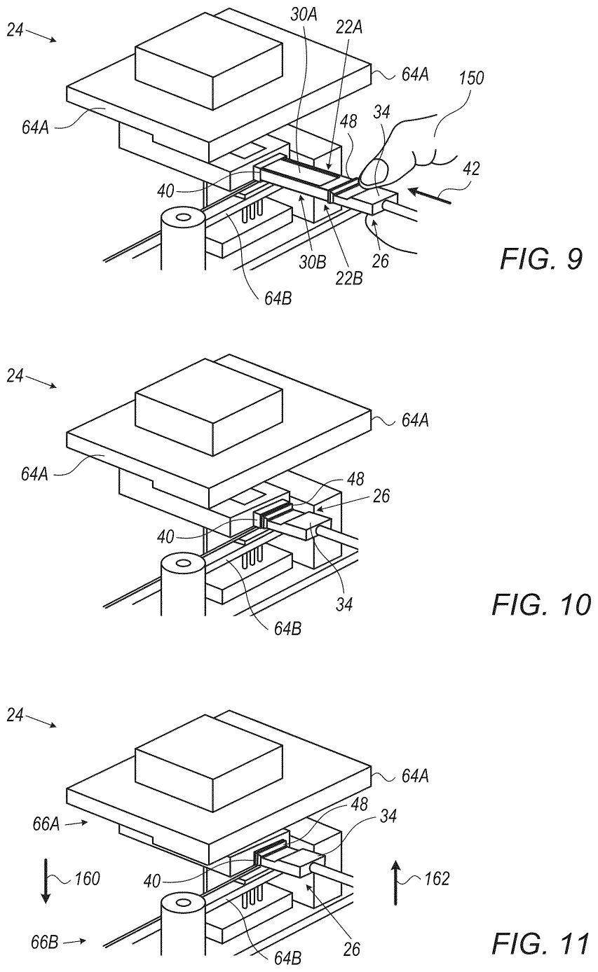

FIG. 9 is a schematic pictorial illustration showing operator 150 inserting applicator housing 34 into receptacle 40 of while pedestals are open, in accordance with an embodiment of the present disclosure. In some embodiments, user 150 can insert applicator housing 34 until stopper 48 meets receptacle 40 (i.e., the stopper meeting the receptacle prevents further insertion of the applicator housing)

FIG. 10 is a schematic pictorial illustration showing applicator housing 34 inserted into receptacle 40, in accordance with an embodiment of the present disclosure. In some embodiments, receptacle 40 receiving applicator housing 34 aligns thermal pads 22 with target surfaces 66.

In step 138, applicator 26 affixes thermal pads 22 to target surfaces 66 in response to moving (i.e. repositioning) pedestals 64 toward each other, so that target surfaces 66 engage (i.e., press against) adhesive sides 30 of thermal pads 22. Pressing target surfaces 66 against adhesive sides 30 of thermal pads 22 affixes (the adhesive sides of the) thermal pads to target surfaces 66.

FIG. 11 is a schematic pictorial illustration showing pedestals 64 moving toward each other (i.e., “closing” the pedestals), as indicated by arrows 160 and 162, in accordance with an embodiment of the present disclosure. In some embodiments, closing pedestals 66 comprises moving top pedestal 64A toward bottom pedestal 64B as indicated by arrow 160 and moving bottom pedestal 64B toward bottom pedestal 64A as indicated by arrow 162. Closing pedestals 66 causes target surfaces 66 to press against applicator housing 34 so as to affix adhesive sides 30 of thermal pads 22 to top and bottom target surfaces 66 in optical transceiver tester 24.

In step 140, suction line 70 terminates delivery of suction 58 to suction ports 56, thereby terminating the suction hold on bottom thermal pad 22B. In some embodiments, suction line 70 terminates delivery of suction 58 to suction ports 56 in response to user 150 cycling manual switch 74 to the off position.

Finally, in step 142, optical transceiver tester 24 allows removal of applicator housing 34 from receptacle 40 in response to moving pedestals 64 away from each other (i.e., “opening” the pedestals), and the method ends.

Systems 20 implementing embodiments of the present disclosure enables also enables multiple operators 150 to operate multiple optical transceiver tester 24, and repeatedly accurately replace thermal pads 22 on target surfaces 66 pads placement. By repeatedly ensuring uniform installation of thermal pads 22 at all target locations in each optical transceiver tester, systems 20 implementing embodiments of the present disclosure can reduce gaps in thermal performance between the optical transceiver testers.

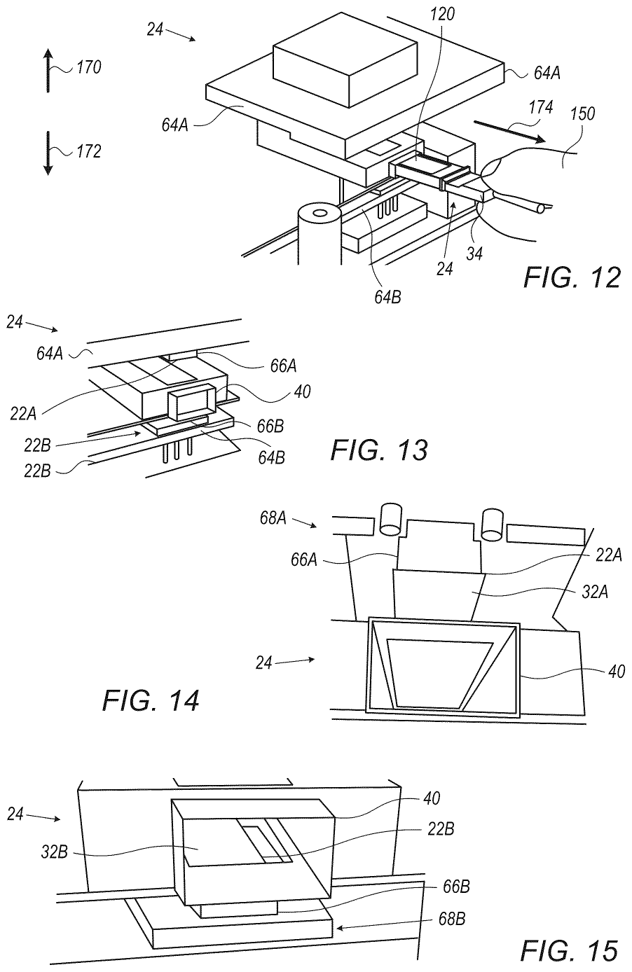

FIG. 12 is a schematic pictorial illustration showing operator 150 removing applicator 26 from receptacle 40 while pedestals 64 are open, in accordance with an embodiment of the present disclosure. In the configuration shown in FIG. 12, opening pedestals 64 comprises moving top pedestal 64A away from bottom pedestal 64B as indicated by an arrow 170, and moving bottom pedestal 64B away from top pedestal 64A as indicated by an arrow 172. Motion of user 150 removing applicator 26 from receptacle 40 is indicated by an arrow 174.

FIG. 13 is a schematic pictorial illustration showing optical transceiver tester 24 subsequent to operator 150 removing applicator 26 from receptacle 40, in accordance with an embodiment of the present disclosure. In the configuration shown in FIG. 13, upper thermal pad 22A is affixed to upper target surface 66A and lower thermal pad 22B is affixed to lower target surface 66B.

FIG. 14 is a schematic pictorial illustration showing top thermal pad 22A affixed to top target surface 66A, in accordance with an embodiment of the present disclosure.

FIG. 15 is a schematic pictorial illustration showing bottom thermal pad 22B affixed to bottom target surface 66B, in accordance with an embodiment of the present disclosure.

### APPENDIX: EXAMPLE USES FOR EMBODIMENTS

Datacenters and other networking systems may include connections between datacenters, switch systems, servers, racks, and devices in order to provide for signal transmission between one or more of these elements. These connections may be made using cables, transceivers, interconnects, interposers, and connector assemblies. For high bandwidth applications and/or connections over long distances, high powered optical communications may be preferred to ensure signal transmission integrity.

Datacenters may include multiple network switches in a particular topology, such as a fat tree topology, a slim fly topology, a dragonfly topology, multi-level fat-trees, fat-flys, Benes, Clos, meshes, and tori and/or the like. The specifications and makeup of the network switches in the topology affects the overall network performance (e.g., bandwidth capability) of the datacenter.

Datacenters are the storage and data processing hubs of the internet. The massive deployment of cloud applications is causing datacenters to expand exponentially in size, stimulating the development of faster switches that can cope with the increasing data traffic inside the datacenter. Current state-of-the-art switches are capable of handling 12.8 Tb/s of traffic by employing electrical switches in the form of application specific integrated circuits (ASICs) equipped with 256 data lanes, each operating at 50 Gb/s. Such switching ASICs typically consume as much as 400 W, and the power consumption of the optical transceiver interfaces attached to each ASIC is comparable. To keep pace with traffic demand, switch capacity doubles approximately every two years.

To date, this rapid scaling has been made possible by exploiting advances in manufacturing (e.g., CMOS techniques), collectively described by Moore's law (i.e., the observation that the number of transistors in a dense integrated circuit doubles about every two years). However, in recent years there are strong indications of Moore's law slowing down, which raises concerns about the capability to sustain the target scaling rate of switch capacity. As a result, alternative technologies are being investigated.

As described supra, datacenters, high performance computing clusters, and/or the like are often formed of various computing components or networked devices, and communication networks formed of electrical and/or optical devices may be used to enable communication between the networked devices forming these implementations.

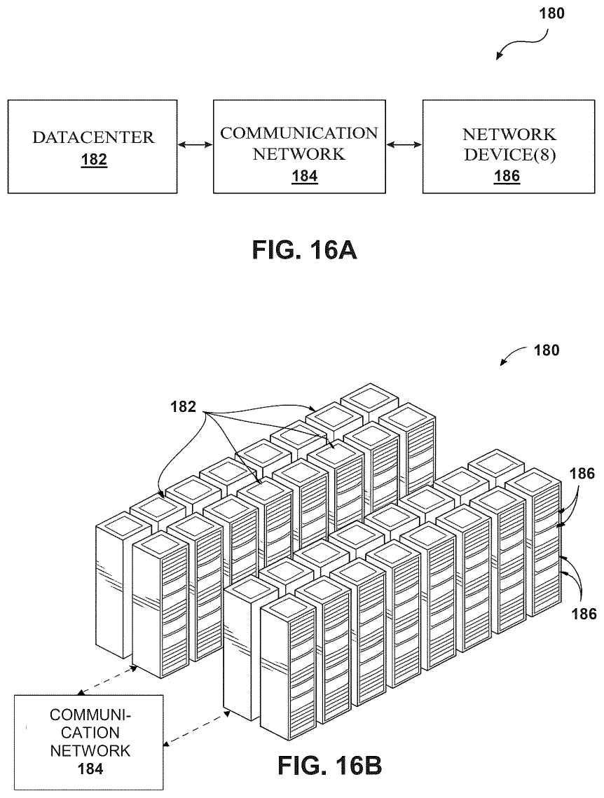

FIG. 16A is a block diagram of a network architecture 180, and FIG. 16B is an illustration of a datacenter 182 implementing the architecture, in accordance with an embodiment of the present disclosure. In embodiments herein, FIGS. 16A and 16B may be collectively referred to as FIG. 16.

In the configuration shown in FIG. 16, network architecture 180 may comprise datacenter 182, a communication network 184, and one or more network device(s) 186. Network architecture 180 may illustrate a general computing architecture within which more specific systems and/or subsystems may function. Although described hereinafter with reference to a network architecture 180 and/or datacenter 182 within which the embodiments of the present disclosure may be implemented, the present disclosure contemplates that the transceiver resiliency devices and techniques described herein may be applicable to any communication implementation without limitation.

For example, datacenter 182 may be a centralized facility designed to house computing resources and related components. Datacenter 182 may operate to support the infrastructure required for advanced computational tasks, for efficient, secure, and reliable operations. Datacenter 182 may include the building and structural components, including power supplies, cooling systems, fire suppression systems, and physical security measures that are configured to maintain optimal operating conditions and/or protect the equipment from environmental hazards and unauthorized access. An example datacenter 182 may include high-performance servers or compute nodes, often arranged in racks, such as those illustrated in FIG. 16B, and connected through high-speed networks as described herein.

These servers may include processors (e.g., central processing units (CPUs), graphics processing units (GPUs), data processing units (DPUs) and/or the like), quantum processing units (QPUs), a plurality of parallel processing units (PPUs), memory (e.g., RAM), and storage solutions (e.g., hard disk drives (HDDs), solid state drives (SSDs), and/or the like. The hardware configuration may be designed for parallel processing and high throughput, catering to the demands of high-performance computing (HPC) applications. QPUs configured to perform one or more operations associated with a quantum algorithm.

In some embodiments, each of the one or more QPUs may include a plurality of qubits and the one or more QPUs may be in communication with each other via a quantum channel. In some embodiments, each of the plurality of qubits may include local qubits, global qubits, and/or synchronization qubits. In some embodiments, the local qubits of each QPU may be configured to perform the one or more operations associated with the quantum algorithm on the QPU with which the local qubits are associated.

Datacenter 182 may include high-speed network equipment, such as network switches, routers, firewalls, and/or the like to facilitate fast and secure data transmission within the datacenter (e.g., between the servers or compute nodes) and between external networks. Datacenter 182 may facilitate communication between servers or compute nodes through a network topology that ensures efficient data exchange, minimizes latency, and maximizes bandwidth. The network topology may dictate how various network devices, such as switches and routers, are interconnected for data flow. By implementing an effective network topology, datacenter 182 may support high-performance computing tasks. Examples of various network topologies may include hierarchical networking topologies such as the fat tree topology, Slim Fly topology, Dragonfly topology, and/or the like.

Communication network 184 may communicably couple the datacenter 102 with network device(s) 186 and other external devices for data exchange and connectivity. Examples of communication network 184 may include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. The ability of communication network 184 to incorporate multiple network types and configurations may allow datacenter 182 to adapt to diverse application needs, from general data communication to specialized HPC tasks.

As described herein, the communication network 184 may leverage various optical components to establish communication links (e.g., communicably couple) between components in architecture 180. As such, communication network 184 may include various optical devices, transceivers, modules, and/or the like that are configured to generate optical signals (e.g., provide optical transmitter functionality) and/or receive optical signals (e.g., provide optical receiver functionality).

Network device(s) 186 may include a variety of computing devices capable of transmitting and receiving signals over communication network 184. Network device(s) 186 may range from personal computing devices to complex server configurations. Examples include Personal Computers (PCs), laptops, tablets, smartphones, and servers. Network device(s) 186 may facilitate user interactions with datacenter 182, allowing for data input, retrieval, and processing from remote locations. In addition to individual computing devices, network device(s) 186 may also include collections of servers or additional datacenters.

For instance, these could be other datacenters similar to or the same as datacenter 182. Such an interconnection may allow for the formation of a distributed computing environment for improved redundancy, load balancing, and disaster recovery capabilities. By linking multiple datacenters, network architecture 180 may leverage geographically dispersed resources, optimizing performance and ensuring high availability.

As described herein, datacenter 182 and/or network device(s) 186 may include storage devices and processing circuitry for executing computing tasks, such as controlling the flow of data internally and over communication network 184. The processing circuitry may include software, hardware, or a combination thereof. For example, the processing circuitry may include a memory containing executable instructions and a processor (e.g., a microprocessor) that executes these instructions. The memory may correspond to any suitable type of memory device or collection of memory devices configured to store instructions.

Non-limiting examples of suitable memory devices include Flash memory, Random Access Memory (RAM), Read Only Memory (ROM), variants thereof, combinations thereof, or similar technologies. In specific embodiments, the memory and processor may be integrated into a common device, such as a microprocessor with integrated memory. Additionally, or alternatively, the processing circuitry may comprise hardware components, such as an application-specific integrated circuit (ASIC). Other non-limiting examples of processing circuitry include Integrated Circuit (IC) chips, CPUs, GPUs, microprocessors, Field Programmable Gate Arrays (FPGAs), collections of logic gates or transistors, resistors, capacitors, inductors, and diodes. Some or all of the processing circuitry may be provided on a Printed Circuit Board (PCB) or a collection of PCBs. It should be appreciated that any appropriate type of electrical component or collection of electrical components may be suitable for inclusion in the processing circuitry.

In addition, although not explicitly shown, the present disclosure contemplates that datacenter 182 and network device(s) 186 may include one or more communication interfaces for facilitating wired and/or wireless communication between one another and other unillustrated elements of network architecture 180. These communication interfaces may include a variety of technologies, including but not limited to Ethernet ports, fiber optic connections, Wi-Fi® transceivers, Bluetooth® modules, and cellular communication modules for integration and interoperability among the various components within network architecture 180.

Furthermore, the present disclosure contemplates that network architecture 180 may include additional components and functionalities. For example, the network architecture may include, without limitation, additional processing units, specialized accelerators (such as Tensor Processing Units or TPUs), enhanced security modules, and redundant power supplies. The inclusion of these elements may be intended to ensure that the network architecture 180 is robust, scalable, and capable of meeting diverse operational requirements. Any variations, modifications, or adaptations of the described elements that fall within the spirit and scope of the disclosure are considered to be encompassed by the present disclosure. This includes any combinations, sub-combinations, or enhancements of the various described elements to achieve improved performance, reliability, and efficiency in the network architecture 180.

In high-capacity datacenter networks, such as those illustrated in FIG. 16, communication network 184 may leverage optical transceivers that transmit and receive optical signals over optical fibers or other optical communication mediums in order to establish connection between devices in architecture 180.

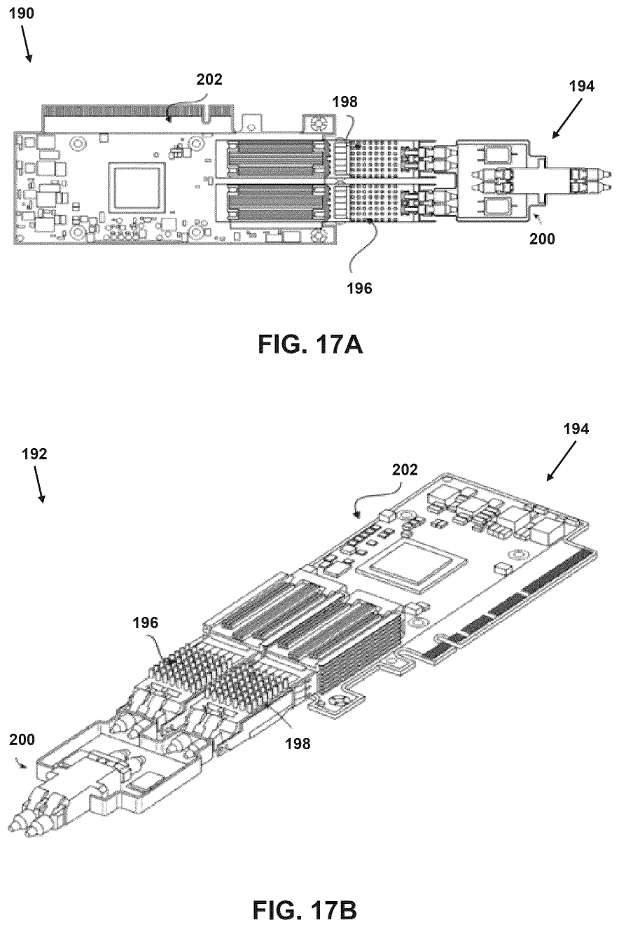

FIGS. 17A and 17B are illustrations showing a top view 190 and a perspective view 192, respectively, of an (optical) transceiver module 194 operatively coupled to a network adapter, in the present example the transceiver module that can couple a given network device 186 to communication network 184, in accordance with an embodiment of the disclosure. In embodiments herein, FIGS. 17A and 17B may be collectively referred to as FIG. 17.

As shown in FIG. 17, transceiver module 194 may include a first optical module 196, a second optical module 198, an adapter 200, and a dual-port NIC 202 of a server. Both first optical module 296 and second optical module 198 may be dual-fiber transceivers that are configured for duplex communication that allows the source (e.g., a g8ven server 106) to communicate with the target (e.g., leaf switch) in both directions. Adapter 200 may be a ganged physical component configured to link first optical module 196 and second optical module 198 for the purpose of transmitting and receiving data to and from the leaf switch.

In some embodiments, adapter 200 may be configured to operate in two configurations, such as a first configuration and a second configuration. In one aspect, the first configuration may be a default configuration of operation, where first optical module 196 may be operationally active. The second configuration may be a contingent configuration that is implemented when first optical module 196 operationally fails. When such a failure is detected, second optical module 198, which is otherwise operationally inactive or idle, may be engaged become operationally active and handle all network traffic that was initially handled by the first optical module.

In some embodiments, transceiver module 194 may be configured to operate in a leaf-spine architecture. A leaf-spine architecture is a data center network topology that may include two switching layers—a spine layer and a leaf layer. The leaf layer may include access switches (leaf switches) that aggregate traffic from servers and connect directly into the spine or network core. Spine switches interconnect all leaf switches in a full-mesh topology between access switches in the leaf layer and the servers from which the access switches aggregate traffic.

As such, in one embodiment, to ensure reliable operation of downlinks, transceiver module 194 may be configured to operate between the server and the leaf layer. In particular, as shown in FIG. 17, adapter 200 may be operatively coupled to first optical module 196 and second optical module 198, while the first optical module and the second optical module may be operatively coupled to dual-port NIC 202 of a server.

In embodiments, transceiver 194 may comprise one or more processing circuits, as detailed above; the processing circuits may comprise FW, that is loaded according to the techniques described above.

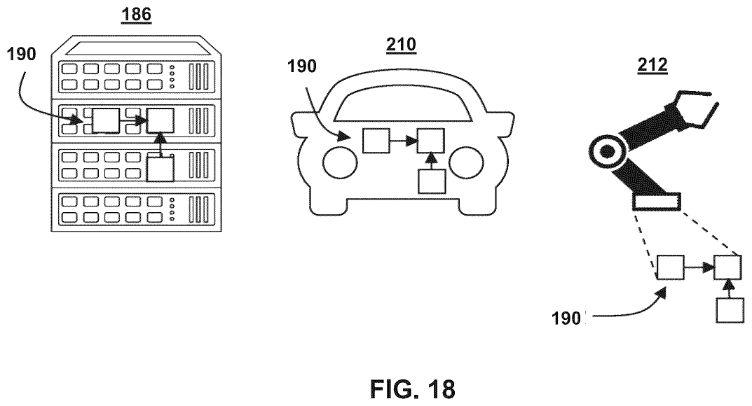

FIG. 18 depicts exemplary scenarios for use of optical transceiver 190, in accordance with some embodiments of the present disclosure. Optical transceiver 190 may be utilized in a network device 186 such as a computing system (e.g., in a server farm, or within a server computer system), a vehicle 210 (e.g., a car, truck, train, or airplane), and a robot 212 (or among robots in a factory), to name just a few examples. Optical transceiver 302 may be particularly useful for high-speed communication in environments subject to high levels of electromagnetic interference (EMI).

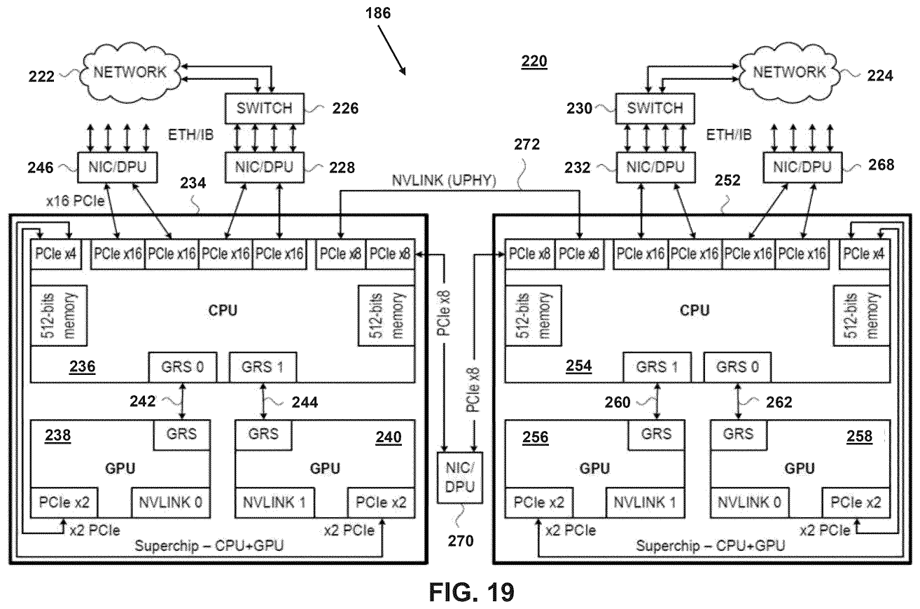

FIG. 19 is a block diagram that schematically illustrates an example of a given network device 186, in accordance with an embodiment of the present disclosure. In the example shown in FIG. 19, network device 186 comprises a computing system 220, e.g., a data center or a High-Performance Computing (HPC) cluster.

System 220 may comprise a plurality of subsystems, e.g. multiple processing devices coupled to each other, multiple network devices, and multiple networks, according to at least one embodiment. Computing system 220 can be designed with multiple integrated circuits (referred to as processing devices), where each integrated circuit can include one or more CPUs and GPUs, forming a powerful and flexible architecture.

The various processing devices are interconnected via an NVLINK or other high-speed interconnect, enabling high-speed communication between the subsystems, and are also connected through a NIC or DPU to ensure efficient data transfer across computing system 220 and to one or more external networks 222 and 224. In the present example, system 220 comprises a packet switch 226 that connects a NIC/DPU 228 to data network 222, and a packet switch 230 that connects a NIC/DPU 232 to data network 224.

The coupling of processing devices through NVLINK allows for seamless data exchange and parallel processing, enhancing overall computational performance. The processing devices are connected to multiple networks through one or more network interface controllers (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 220 can include one or more CPUs and one or more GPUs.

FIG. 19 also shows an example architecture of a multi-GPU architecture. As illustrated in the figure, computing system 220 comprises a processing device 234 with a multi-GPU architecture. In particular, processing device 234 may be a system-on-chip and includes multiple subsystems such as a CPU 236, a GPU 238, and a GPU 240 CPU 236 can be coupled to GPU 238 via a die-to-die (D2D) or chip-to-chip (C2C) interconnect 242, such as a Ground-Referenced Signaling interconnect (GRS interconnect). CPU 236 can be coupled to GPU 240 via a D2D or C2C interconnect 244. CPU 236 can also couple to GPU 238 and GPU 240 via PCIe interconnects.

CPU 236 can be coupled to one or more NICs or DPUs, which are coupled to one or more networks. For example, as illustrated in FIG. 3, CPU 236 is coupled to a first NIC/DPU 246, which is coupled to a network 248. CPU 236 is also coupled to a second NIC/DPU 250, which is coupled to network 1030 via switch 1048. NIC/DPU 1026 and NIC/DPU 1028 can be coupled to network 248 over Ethernet (ETH), NVLINK or InfiniBand (IB) connections, for example.

Computing system 220 also includes a processing device 252 with a multi-GPU architecture. In particular, processing device 252 includes multiple subsystems including a CPU 254, a GPU 256, and a GPU 258. CPU 254 can be coupled to GPU 256 via a D2D or C2C interconnect 260. CPU 254 can be coupled to GPU 258 via a D2D or C2C interconnect 262. CPU 224 can also be coupled to GPU 256 and GPU 258 via PCIe interconnects. CPU 254 can be coupled to one or more NICs or DPUs, which are coupled to one or more networks. For example, as illustrated in FIG. 3, CPU 254 is coupled to a first NIC/DPU 264, which is coupled to a data network 266. CPU 254 is also coupled to a second NIC/DPU 268, which is coupled to network 266 via a switch 230. NIC/DPU 264 and NIC/DPU 268 can be coupled to network 266 over Ethernet (ETH), NVLINK or InfiniBand (IB) connections.

In at least one embodiment, processing device 234 and processing device 252 can communicate with each other via a NIC/DPU 270, such as over PCIe interconnects. Processing device 1002 and processing device 1004 can also communicate with each other over a high-bandwidth communication interconnect 272, such as an NVLINK interconnect or other high-speed interconnects. The packet switches in FIG. 3 may comprise, for example, NVIDIA QUANTUM-2 switches. The NICs/DPUs in the figure may comprise, for example, NVIDIA BLUEFIELD DPUs.

In embodiments described hereinabove, tester 24 can be used for testing devices such as optical transceiver 190. In some embodiments optical transceiver 190 may be deployed as a component in computing system 220, and be used in conjunction with network devices in system 220, e.g., any of NICs/DPUs 246, 228, 264, 268 and 270, and/or any of switches 226 and 230.

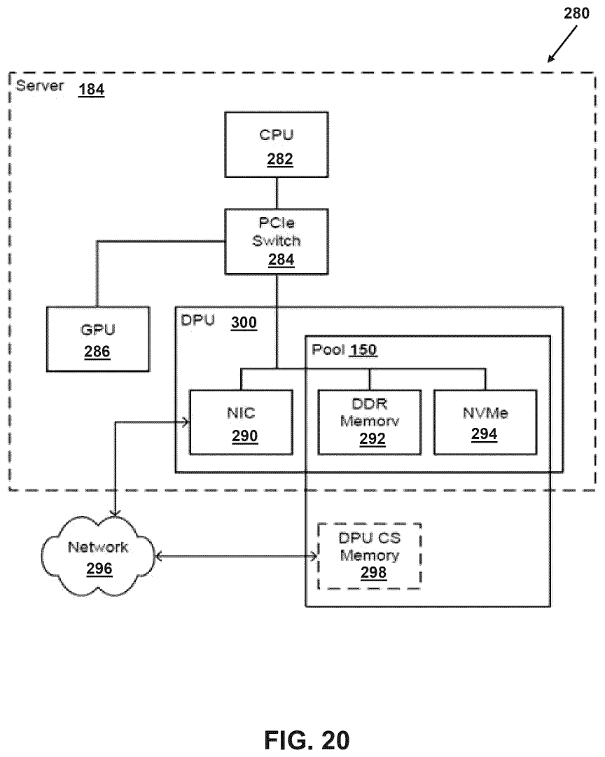

FIG. 20 illustrates an example of a computing environment 280, in accordance with at least one embodiment of the present disclosure. In some embodiments, computing environment 280 may be deployed in datacenter 182 as a given network device 186 such as a server.

In the configuration shown in FIG. 20, computing environment 280 may be configured to implement forward pass offloading to available memory. It should be appreciated that embodiments of the present disclosure may also be used with reference to alternative environments and that specific discussion of components may be provided by way of non-limiting example and may include equivalents. Moreover, various features have been removed for clarity and conciseness. Additionally, systems and methods may be used with a variety of different architectures. The example computing environment 280 may include server 186 which may be used to perform HPC workloads, such as AI training or machine learning model training. In an embodiment, server 186 may be an application instance or a compute node. Server 186 may include a CPU 282 associated with a switch 284 such as a peripheral component interconnect express (PCIe) switch, which may control at least some data transmission over communication paths interconnecting various components. In an embodiment, CPU 282 may include a root complex processor.

PCIe switch 284 may also be associated with a GPU 286 and a DPU 288, and may transmit data between at least some of CPU 282, GPU 286, DPU 288, and other components. In one embodiment, PCIe switch 284 may be associated with more than one GPU or more than one DPU. In another embodiment, PCIe switch 284 may be located within DPU 288. PCIe switch 284 may manage the transfer of at least some data between CPU 282, GPU 286, and DPU 288. In another embodiment, the number of GPUs associated with PCIe switch 284 may be equal to the number of DPUs associated with PCIe switch 284.

In at least one embodiment, server 186 may include, without limitation, any number of the CPUs 282, the PCIe switches 284, the GPUs 286, and/or the DPUs 288, in any combination. For example, in at least one embodiment, server 186 could include eight, sixteen, thirty-two, and/or more GPUs 286. In at least one embodiment, communication paths interconnecting various components, including but not limited to CPU 282, PCIe switch 284, GPU 286, and DPU 288, in FIG. 20 may be implemented using any suitable protocols, such as peripheral component interconnect (PCI) based protocols (e.g., PCIe), or other bus or point-to-point communication interfaces and/or protocol(s), such as NV-Link high-speed interconnect, or interconnect protocols.

DPU 288 may include a network interface controller (NIC) 290, a DDR memory 292, and a non-volatile memory express (NVMe) device 294. NIC 290 may be able to interface with network 296, which may also interface with additional NVMe devices available to DPU 288, such as over fabric. In an embodiment, DPU 288 may not include NVMe device 294. In another embodiment, NVMe device 294 may be located on the server 186 and not on DPU 288. In yet another embodiment, the computing environment 280 may include more than one of NVMe device 294, such as a first NVMe device 294 in DPU 288 and a second NVMe device 294 on server 286 ans associated directly with PCIe switch 284.

In an embodiment, DPU 288 may not include the DDR memory 292, and may include computational storage services (CSS) in place of, or in addition to, the DDR memory. For example, computing environment 280 may include a DPU computational storage (CS) memory 298 available to DPU 288 as part of the CSS. Network 296 may be able to interface with the DPU CS memory 298 through the NIC 290, according to any suitable interface protocol, such as remote direct memory access (RDMA) over Ethernet, InfiniBand, Fiber Channel, etc.

The total memory of the computing environment 280 available for data storage may be expanded through the use of DPU 288 on nodes of the system. DPU 288 may have access to a pool 300 of memory already available to server 186, such as double data rate (DDR) memory, on-board NVMe devices, NVMe devices over fabric, and CS. Pool 300 of memory may include at least one of the DDR memory 292, NVMe 294, and DPU CS memory 298. DPU 288 may also be able to access the available memory of other DPUs as part of pool 300, and other DPUs may be able to access the available memory of DPU 288, such as pool 300. This available memory can be accessed and utilized for data storage, without the addition of compute resources, such as compute nodes, which would be required using other solutions.

Available pool 300 accessible to DPU 288 may be provisioned for server 186 to expand the total memory available for data storage, such as to reduce the data storage load on CPU 282 or the GPU 286, which can instead increase the utilization of their memory for processing. For example, during training of an AI, the model states, residual states, activation functions, and checkpoints can be stored, or offloaded, on pool 300 accessible to DPU 288.

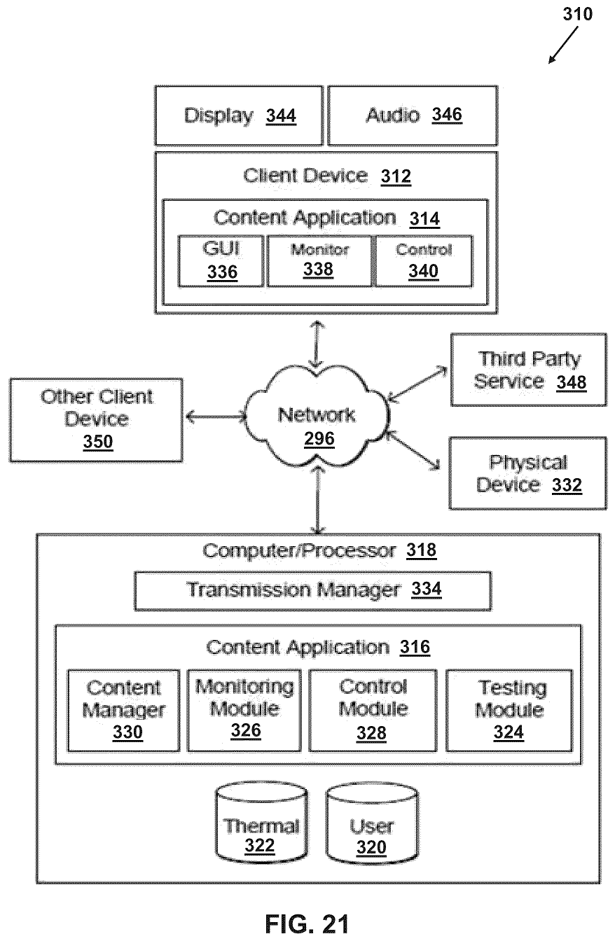

FIG. 21 illustrates an example network configuration 310 of components that can be used to provide, generate, modify, encode, process, fuse, and/or transmit generated image data, calculated measurements, or other such content, in accordance with an embodiment of the present disclosure.

In at least one embodiment, a client device 312 can generate or receive data for a session using components of a content application 314 on the client device and data stored locally on that client device. In at least one embodiment, a content application 316 executing on a computer or processor 318 (e.g., a cloud server or control system) may initiate a session associated with at least one client device 312 (e.g., a vehicle or robot), as may use a session manager and user data stored in a user database 320, and can cause content such as liquid coolant or server thermal data to be selected and/or retrieved from a repository 322 to be used by a testing module 324 to calculate one or more performance metrics for a monitoring module 326, which can provide flow data or thermal data to a control module 328 to control a flow or temperature, in an environment where the data is to be used to determine appropriate operation.

A content manager 330 may work with these various modules to perform testing and analysis, and potentially instruct any actions to be taken in response to a performance metric failing to satisfy any operational requirements. At least a portion of this data or instructional content can be transmitted to client device 312 and/or a physical device 332 using an appropriate transmission manager 334 to send by download, streaming, or another such transmission channel. An encoder may be used to encode and/or compress at least some of this data before transmitting this data to client device 312.

In at least one embodiment, client device 312 receiving such content can provide this content to a corresponding content application 314, which may also or alternatively include a graphical user interface 336, a flow monitor module 338, and a control module 340 for use in providing, synthesizing, rendering, compositing, modifying, or using content for presentation, navigation, control, (or other purposes) on or by client device 312, such as may be transmitted to physical device 332.

In some embodiments, computer/processor 318 and client device 312 may be able to communicate directly without needing to transmit data over a data network 342, in order to avoid issues with latency and availability, etc. A decoder may also be used to decode data received over network 342 for presentation via client device 312, such as imaging content or performance metrics through a display device 344 and audio, such as corresponding sounds or synthesized speech, through at least one audio playback device 346, such as speakers or headphones.

In at least one embodiment, at least some of this content may already be stored on, rendered on, or accessible to client device 312 such that transmission over network 342 is not required for at least that portion of content, such as where that content (e.g., thermal data) may have been previously downloaded or stored locally on a hard drive or optical disk.

In at least one embodiment, a transmission mechanism such as data streaming can be used to transfer this content from computer/processor 318, or user database 320, to client device 312.

In at least one embodiment, at least a portion of this content can be obtained, enhanced, and/or streamed from another source, such as a third-party service 348 or other client device 350, that may also include a content application for generating, updating, enhancing, or providing map content.

In at least one embodiment, portions of this functionality can be performed using multiple computing devices, or multiple processors within one or more computing devices, such as may include a combination of CPUs and GPUs (Graphics Processing Unit).

In at least some of these examples, client devices can include any appropriate computing devices, as may include a desktop computer, notebook computer, set-top box, streaming device, gaming console, smartphone, tablet computer, VR headset, AR goggles, wearable computer, or a smart television. Each client device can submit a request across at least one wired or wireless network, as may include the Internet, an Ethernet, a local area network (LAN), or a cellular network, among other such options. In this example, these requests can be submitted to an address associated with a cloud provider, who may operate or control one or more electronic resources in a cloud provider environment, such as may include a data center or server farm.

In at least one embodiment, the request may be received or processed by at least one edge server, that sits on a network edge and is outside at least one security layer associated with the cloud provider environment. In this way, latency can be reduced by allowing the client devices to interact with servers that are in closer proximity, while also improving security of resources in the cloud provider environment.

In at least one embodiment, such a system can be used for monitoring or managing thermal conditions of a server which includes cold plates as liquid manifolds. In other embodiments, such a system can be used for other purposes, such as for providing control of liquid coolant flow, or for performing deep learning operations. In at least one embodiment, such a system can be implemented using an edge device or may incorporate one or more Virtual Machines (VMs). In at least one embodiment, such a system can be implemented at least partially in a data center or at least partially using cloud computing resources.

The systems and methods described herein may be implemented across a range of data center and high-performance computing environments. In some embodiments, components may include one or more optical transceivers, photonic integrated circuits (PICs), electronic processors, memory units, and programmable logic (e.g., FPGAs or ASICs).

The system architecture may include a layered protocol stack enabling optical interconnects between compute nodes, GPUs, or switch fabrics. Although described in the context of optical signaling (e.g., PAM4 modulation over silicon photonics), the methods may be adapted for use in electrical signaling environments or hybrid opto-electrical systems.

Aspects of the disclosed technology may be implemented in hardware, software, firmware, or combinations thereof. For example, a congestion-aware routing module may be realized as a hardware IP block, or as software instructions executing on a network controller.

The system may include machine-readable instructions stored in non-transitory memory that, when executed, cause the system to perform steps such as: dynamic wavelength assignment, error correction encoding, channel bonding, or adaptive modulation format selection.

In some implementations, system components may be distributed across multiple dies or chiplets interconnected via high-speed SerDes lanes, optical waveguides, or interposer-based photonic links. Embodiments may support scaling from single-link configurations to mesh, torus, or custom topologies based on application workload requirements.

As used herein, terms like “transmit unit,” “controller,” “interconnect fabric,” or “node” are not limited to any specific implementation, and may encompass hardware, virtualized, or software-defined instances depending on deployment context.

It will be appreciated that the embodiments described above are cited by way of example, and that the present disclosure is not limited to what has been particularly shown and described hereinabove. Rather, the scope of the present disclosure includes both combinations and subcombinations of the various features described hereinabove, as well as variations and modifications thereof which would occur to persons skilled in the art upon reading the foregoing description and which are not disclosed in the prior art.

1. An apparatus, comprising:
an applicator having an applicator housing to engage a thermal pad, the applicator housing comprising one or more suction ports coupled to a vacuum generator to generate a suction hold on the thermal pad in response to the suction generated by the vacuum generator.

2. The applicator according to claim 1, wherein the vacuum generator operates using 6 bar compressed air.

3. The applicator according to claim 1, wherein the vacuum generator comprises a Venturi vacuum generator.

4. The applicator according to claim 1, wherein the applicator housing is to engage the thermal pad by engaging a non-adhesive side of the thermal pad, and wherein the suction hold on the non-adhesive side of the thermal pad affixes a second, adhesive side of the thermal pad to a target surface in a tester.

5. The applicator according to claim 4 wherein the tester comprises a receptacle to receive a transceiver module, and wherein the applicator housing has an external form factor shaped to fit into the receptacle.

6. The applicator according to claim 5, wherein the external form factor comprises a network transceiver form factor.

7. The applicator according to claim 6, wherein the network transceiver form factor comprises a Small Form-factor Pluggable (SFP) form factor.

8. The applicator according to claim 5, wherein the receptacle aligns the thermal pad with the target surface upon receiving the applicator.

9. The applicator according to claim 4, wherein the tester comprises a heat sink, and wherein the target surface is coupled to the heat sink.

10. The apparatus according to claim 4, wherein the applicator housing comprises:
a recessed cutout formed in a side of the applicator housing to encompass the non-adhesive side of the thermal pad, wherein the recessed cutout comprises the one or more suction ports;
an internal channel disposed within the applicator housing; and
a suction inlet to connect to the vacuum generator for introducing the suction to the internal channel,
wherein the internal channel leads from the suction inlet to the one or more suction ports in the recessed cutout, so that the one or more suction ports generate the suction hold on the non-adhesive side of the thermal pad in response to introducing the suction to the suction inlet.

11. The applicator according to claim 10, wherein the applicator housing is to affix the second adhesive side of the thermal pad to the target surface in response to repositioning the target surface so as to engage the adhesive side of the thermal pad.

12. The applicator according to claim 10, wherein the thermal pad comprises a first thermal pad, wherein the recessed cutout comprises a first recessed cutout, and wherein the target surface comprises a first target surface, and further comprising a second recessed cutout formed in a second side of the applicator housing to encompass a non-adhesive side of a second thermal pad also having a second, adhesive side.

13. The applicator according to claim 12, wherein the applicator housing is to affix the adhesive side of the second thermal pad to a second target surface.

14. The applicator according to claim 13, wherein the applicator housing is to affix the second adhesive side of the second thermal pad to the target surface in response to repositioning the second target surface so as to engage the adhesive side of the second thermal pad.

15. The applicator according to claim 12, wherein the second side of the applicator housing is opposite the first side of the applicator housing.

16. A method for affixing a thermal pad to a target surface within a tester, comprising:
engaging a first side of the thermal pad to a side of an applicator housing of an applicator, the side of the applicator housing comprising one or more suction ports;
applying a vacuum to the one or more suction ports so as to generate a suction hold on the first side of the thermal pad; and
affixing the applicator to a target surface so as to engage a second side of the thermal pad, thereby securing the thermal pad to the target surface.

17. The method according to claim 16, wherein engaging the first side of the thermal pad to the side of an applicator housing comprises the applicator housing engaging a non-adhesive side of the thermal pad.

18. The method according to claim 17 wherein engaging the non-adhesive side of the thermal pad comprises engaging, by a recessed cutout formed in a side of the applicator housing to encompass the thermal pad, the non-adhesive side of the thermal pad, wherein the recessed cutout comprises the one or more suction ports.

19. The method according to claim 18, wherein affixing the second adhesive side of the thermal pad to the target surface comprises repositioning the applicator housing comprising the target surface so as to engage the adhesive side of the thermal pad.

20. The method according to claim 18, wherein the thermal pad comprises a first thermal pad, wherein the recessed cutout comprises a first recessed cutout, and wherein the target surface comprises a first target surface, and further comprising engaging, by a second recessed cutout formed in a second side of the applicator housing to encompass a second thermal pad, a non-adhesive side of a second thermal pad also having a second, adhesive side.

21. The method according to claim 20, and further comprising affixing the adhesive side of the second thermal pad to a second target surface in response to repositioning the applicator housing comprising the second target surface.
